(19) United States
(12) Patent Application Publication
(10) Pub. No.: US 2011/0103000 A1
(43) Pub. Date: May 5, 2011

(54) BRACKET FOR HARD DISK DRIVE AND ELECTRONIC DEVICE

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/857,679

(22) Filed: Aug. 17, 2010

(30) Foreign Application Priority Data
Oct. 29, 2009 (CN) 200910309071.9

(51) Int. Cl. G06F 1/16; F16M 13/02

(52) U.S. Cl. 361/679.33; 248/225.11; 248/222.14

(57) ABSTRACT

An electronic device includes a hard disk drive (HDD) with multiple mounting poles protruding from two opposite sides thereof and a bracket securing the HDD thereon. The bracket includes a beam, two securing plates extending from two opposite ends of the beam along a substantially same direction, and a positioning member. The securing plates include multiple latching grooves defined in top portions thereof. The latching grooves correspond to the mounting poles. Each latching groove includes a receiving slot allowing extension of a corresponding mounting pole therethrough and a position niche allowing the corresponding mounting pole to slide therein. The position niche communicates with the receiving slot. The positioning member is positioned in the beam and slides towards the HDD to urge the mounting poles in the latching groove from the receiving slot to the position niche.

### BACKGROUND

1. Technical Field

The disclosure relates to a bracket for hard disk drives and an electronic device including the bracket and the hard disk drive.

2. Description of Related Art

Computers have become an indispensable part of our daily life. In a typical computer, a hard disk drive (HDD) is needed to store information. The HDD is usually mounted in a bracket mounted in a rack of the computer. The HDD is directly inserted into the bracket, and a large number of screws extend through sidewalls of the bracket to fix the HDD to the bracket. However, mounting and removing the HDD to and from the bracket requires a tool to fasten and remove the screws. Thus, the assembly and disassembly of the HDD are not only time-consuming but also laborious.

What is needed, therefore, is a bracket for hard disk drives and electronic devices, which overcomes the above-mentioned limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric, exploded view of an embodiment of an electronic device, the electronic device including a hard disk drive (HDD) and a bracket for mounting the HDD therein.

FIG. 2 is an inverted view of FIG. 1.

FIG. 3 is an isometric, assembled view of the HDD assembled to and unlocked with the bracket of FIG. 1.

FIG. 4 is an isometric, assembled view of the HDD assembled to and locked with the bracket of FIG. 1.

FIG. 5 is a cross-section view of the assembly of the HDD on the bracket of FIG. 4, taken along line V-V thereof.

### DETAILED DESCRIPTION

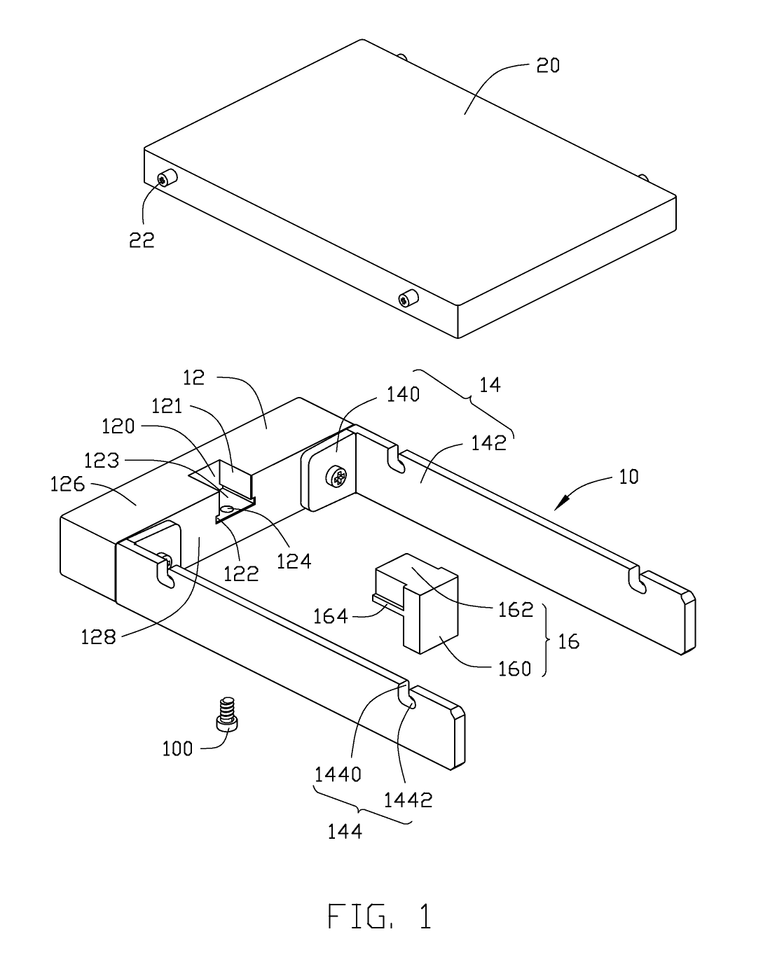

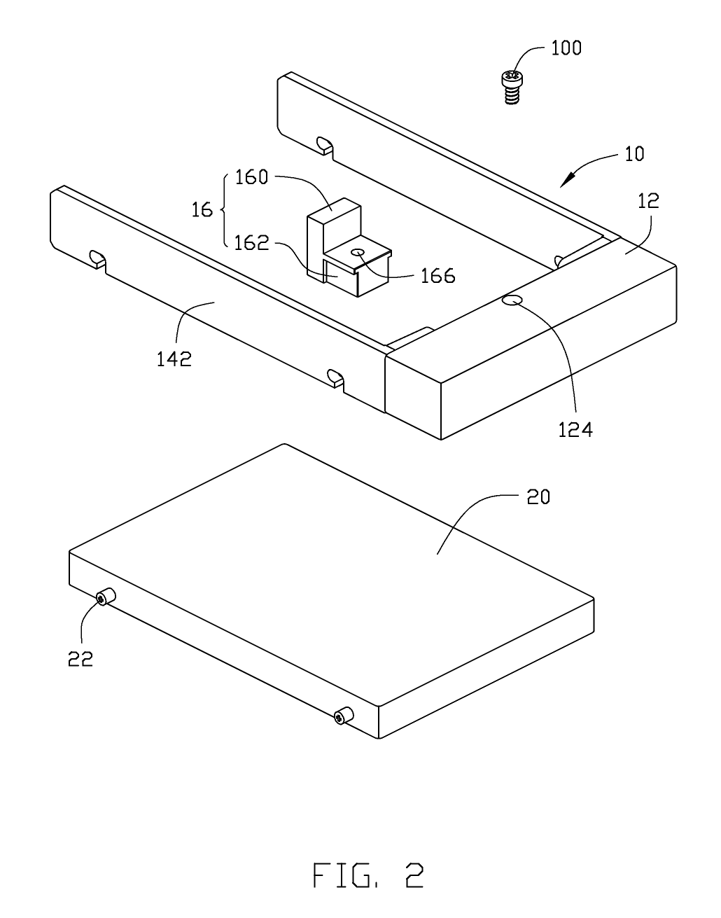

Referring to FIGS. 1-2, an electronic device includes a hard disk drive (HDD) 20 and a bracket 10 for mounting the HDD 20 on a rack of a computer (not shown). The bracket 10 includes an elongated beam 12, two mounting members 14 extending from two opposite ends of the beam 12 along a substantially same direction, and a positioning member 16. The beam 12 and the mounting members 14 cooperatively define a receiving space (not labeled) for receiving the HDD 20.

The beam 12 can have a rectangular cross-section. A length of the beam 12 is slightly larger than a width of the HDD 20. The beam 12 includes a top surface 126, an inner surface 128 facing the HDD 20, and a recess 120 defined in a middle portion of the beam 12. The recess 120 extends upwardly through the top surface 126 of the beam 12 and inwardly through the inner surface 128. The beam 12 comprises two opposite sidewalls 121 and a bottom wall 123 in the recess 120. A bottom portion of each sidewall 121 comprises an elongated slot 122. The slot 122 extends along a direction substantially perpendicular to the lengthwise direction of the beam 12. The bottom wall 123 of the recess 120 comprises a through hole 124.

Each mounting member 14 can have a substantially L-shaped configuration. The mounting member 14 includes a connecting plate 140 and a securing plate 142 extending substantially perpendicularly from an outer end of the connecting plate 140. The connecting plates 140 of the two mounting members 14 are secured to the inner surface 128 of the beam 12 via screws (not labeled). The securing plates 142 of the mounting members 14 are substantially coplanar with the opposite ends of the beam 12. The securing plates 142 are spaced apart from and substantially parallel to each other. A distance between the securing plates 142 is identical to or slightly larger than the width of the HDD 20 so that the HDD 20 is sandwiched between the securing plates 142. A number of spaced latching grooves 144 are located in a top portion of each securing plate 142. In the illustrated embodiment, the number of the latching grooves 144 is two. Each latching groove 144 is substantially L-shaped, and comprises a vertical receiving slot 1440 and a horizontal position niche 1442 extending from the receiving slots 1440 along a direction away from the beam 12.

The positioning member 16 can be substantially L-shaped, and includes a vertical resisting portion 160 and a horizontal inserting portion 162 extending substantially perpendicularly from a top end of the resisting portion 160. Two elongated protrusions 164 protrude outwardly from two opposite sides of the inserting portion 162 and are located at a bottom portion of the inserting portion 162. The inserting portion 162 with the protrusions 164 has the same cross-section as the recess 120 with the slots 122 so that the inserting portion 162 is inserted into the recess 120. The inserting portion 162 comprises a blind screw hole 166 defined in a bottom surface thereof. When the inserting portion 162 is inserted into the recess 120, the protrusions 164 of the inserting portion 162 are received into the slots 122 of the recess 120, thereby preventing the inserting portion 162 from sliding upward away from the recess 120.

The HDD 20 includes two opposite sidewalls 24. Each sidewall 24 includes two spaced mounting poles 22.

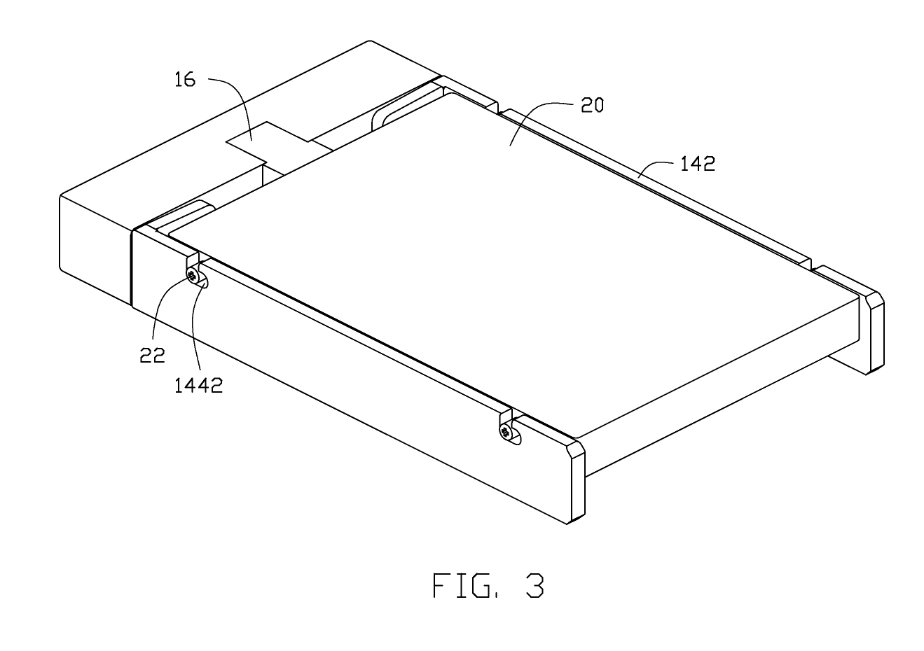

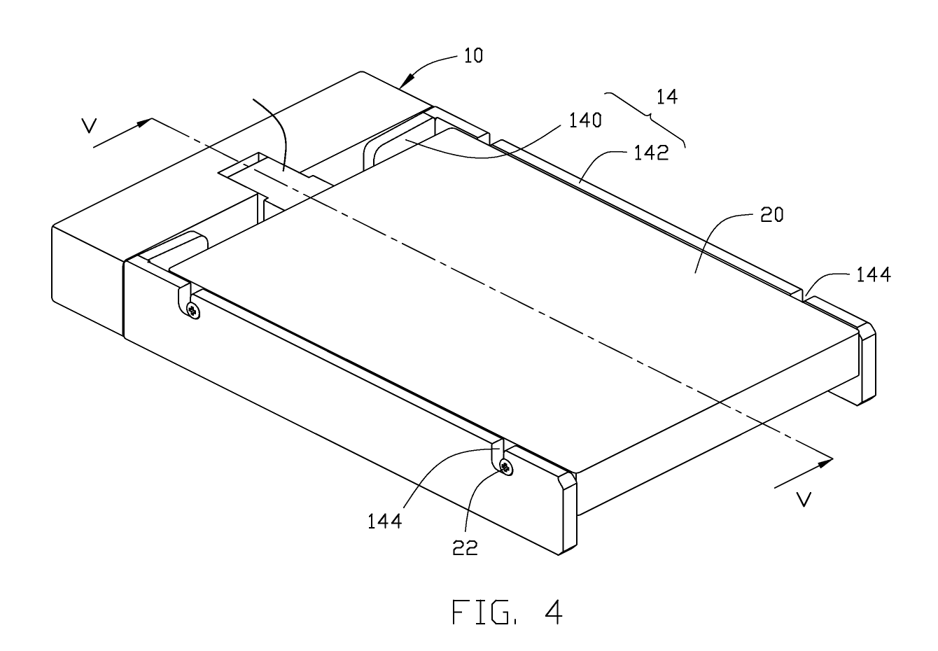

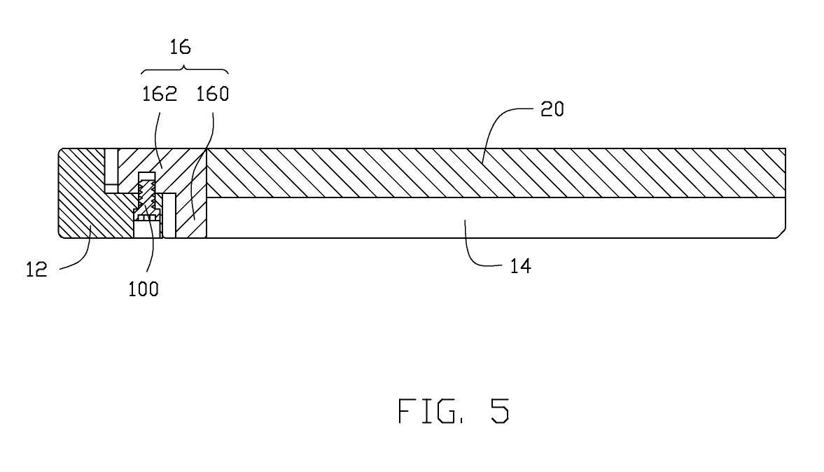

Referring also to FIG. 3, to position the HDD 20 sandwiched between the securing plates 142, the positioning member 16 slides into the recess 120 of the beam 12, and the mounting poles 22 of the HDD 20 slide into the corresponding receiving slots 1440 of the latching grooves 144. An end of the HDD 20 abuts the resisting portion 160 of the positioning member 16, and the inserting portion 162 is wholly received in the recess 120 (viewed in FIG. 3). At the same time, the HDD 20 is unlocked from the bracket 10. Referring also to FIGS. 4-5, when urging the positioning member 16 towards the HDD 20, the HDD 20 is also urged to cause the mounting poles 22 to slide into the position niches 1442 of the latching grooves 144. The blind screw hole 166 of the positioning member 16 is in alignment with the through hole 124 of the recess 120. A fastener 100 extends upwardly through the through hole 124 to engage into the blind screw hole 166, thereby preventing the mounting poles 22 from sliding back to the receiving slots 1440. At the same time, the HDD 20 is locked with the bracket 10.

In disassembly, the fastener 100 must be taken out of the through hole 124 of the recess 120, and then the HDD 20 is urged towards the beam 12 to cause the mounting poles 22 to slide out from the receiving slots 1440, disassembling the HDD 20 from the bracket 10. From the above description, the bracket 10 has a simple structure, and the assembly or disassembly of the HDD is not only quick, but also convenient.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A bracket for a hard disk drive (HDD) with multiple mounting poles protruding from two opposite sides thereof, the bracket comprising:
a beam;
two securing plates extending from two opposite ends of the beam along a substantially same direction, the securing plates comprising multiple latching grooves defined in top portions thereof, the latching grooves corresponding to the mounting poles, each latching groove comprising a receiving slot allowing extension of a corresponding mounting pole therethrough, and a position niche allowing the corresponding mounting pole to slide therein, the position niche communicating with the receiving slot; and
a positioning member positioned in the beam and sliding towards the HDD for urging the mounting poles in the latching groove from the receiving slot to the position niche.

2. The bracket of claim 1, wherein the receiving slots of the latching grooves extend downwardly from the top portions of the securing plates, and the position niches of the latching grooves extend from the receiving slots along a direction away from the beam.

3. The bracket of claim 1, wherein each latching groove is L-shaped.

4. The bracket of claim 1, wherein the positioning member comprises a resisting portion for resisting an end of the HDD and an inserting portion extending towards the beam from an end of the resisting portion, the inserting portion inserting into the beam.

5. The bracket of claim 4, wherein the beam has a top surface and an inner surface, the beam comprising a recess defined upwardly through the top surface and inwardly through the inner surface, the inserting portion being received in the recess.

6. The bracket of claim 5, wherein the recess is located at a middle portion of the beam.

7. The bracket of claim 5, wherein the inserting portion has two protrusions protruding outwardly from two opposite sides thereof, the recess having two opposite sidewalls, the sidewalls defining two slots receiving the protrusions therein.

8. The bracket of claim 7, wherein each of the protrusions is elongated, and each of the slots is elongated.

9. The bracket of claim 7, wherein the recess of the beam has a bottom wall, the bottom wall defining a through hole; the inserting portion comprises a blind screw hole defined in a bottom surface thereof, the blind screw hole corresponding to the through hole; the positioning member urges the mounting poles from the receiving slots to the position niches of the latching grooves.

10. The bracket of claim 9, further comprising a fastener extending through the through hole of the beam to engage into the blind screw hole of the inserting portion, thereby securing the positioning member to the beam.

11. The bracket of claim 1, further comprising two connecting plates secured to the beam, wherein the connecting plates connects respectively with ends of the securing plates, the connecting plates being substantially perpendicular to the securing plates.

12. An electronic device comprising:
a hard disk drive (HDD) with multiple mounting poles protruding from two opposite sides thereof;
a bracket securing the HDD thereon, the bracket comprising a beam, two securing plates extending from two opposite ends of the beam along a substantially same direction and a positioning member;
wherein the securing plates comprises multiple latching grooves defined in top portions thereof, the latching grooves corresponding to the mounting poles, each latching groove comprising a receiving slot allowing extension of a corresponding mounting pole therethrough and a position niche allowing the corresponding mounting pole to slide therein, the position niche communicating with the receiving slot, the positioning member being positioned in the beam and sliding towards the HDD to urge the mounting poles in the latching groove from the receiving slot to the position niche.

13. The electronic device of claim 12, wherein each latching groove is L-shaped.

14. The electronic device of claim 12, wherein the positioning member comprises a resisting portion resisting an end of the HDD and an inserting portion extending towards the beam from an end of the resisting portion, the inserting portion inserting into the beam.

15. The electronic device of claim 14, wherein the beam comprises a recess defined in a middle portion thereof, two opposite sidewalls of the recess, and two slots defined in the opposite sidewalls of the beam; the inserting portion of the positioning member comprises two protrusions protruding from two opposite sides of the inserting portion; the protrusions slide in the corresponding slots of the beam.
